(19) United States
(12) Patent Application Publication
(10) Pub. No.: US 2011/0004571 A1
(43) Pub. Date: Jan. 6, 2011

(54) USE OF COLOR TO IDENTIFY OR UNIFY AS WELL AS TO DIFFERENTIATE PRODUCTS IN A PRODUCT LINE

(76) Inventors: Rita M. Parikh, Paramus, NJ (US); Zhen Zhang, Basking Ridge, NJ (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 12/496,794

(22) Filed: Jul. 2, 2009

(51) Int. Cl. G06Q 90/00

(52) U.S. Cl. 705/500

(57) ABSTRACT

A method of identifying and unifying a product line containing a plurality of product variants all sharing a primary characteristic for which the product line is known. The method involves associating all variants with a single color family that becomes an indicator of the product line. The variants are all associated with a color from the single color family, but each variant is associated with a unique and different color within the single color family. A product line thus is provided in a single color family, but with different variants associated with different colors within that single product-line-identifying color family.

### FIELD OF THE INVENTION

The present invention is directed to differentiation of products in a product line, the products all having a primary attribute common to and identified with the product line. More particularly, the present invention relates to the use of a color family and variations in such color family to associate as well as to differentiate products in a given product line.

### BACKGROUND OF THE INVENTION

Retail stores (such as supermarkets, pharmacies, “superstores,” and warehouse club stores) typically arrange similar products together so that consumers can readily locate products they wish to purchase. Products typically are grouped according to category (e.g., oral care, wound care, hair care, baby, makeup, cleansers and cleaning supplies, paper goods, pharmacy goods, over-the-counter medicines, cereals, beverages, dairy, meat, frozen foods, canned goods, snacks, breads, baking items, pet food and pet care items, toys, movies, electronics, and stationery supplies) in which the products may be said to belong. Within each product category, products typically are further segregated by product segment. For instance, the oral care product category includes toothpaste, mouthwash, dental floss, and toothbrush product segments; the wound care product category includes cleansers, wound treatments (such as topical antibiotics), and bandage product segments; the hair care product category includes shampoo, hair styling, hair accessory, and hair brush product segments. Similar principles are applied to other retail products or items. The different products in a given segment may vary by any of a variety of features that products in such product segment may have (e.g., flavor, fragrance, color, ingredients, additives, size, brand, material, etc.). Each variant in the product segment typically is assigned its own unique SKU (stock keeping unit).

In marketing, product differentiation is the process of distinguishing the differences of a product or offering from others, to make it more attractive to a particular target market. This typically involves differentiating the product from competitors' products. However, manufacturers may also sell more than one product in a given product segment and may choose to utilize product differentiation to differentiate among their own products. As understood herein, a product line is a group or collection of closely related products offered or manufactured by a common source that are considered a unit because of marketing, technical, or end use considerations, yet typically satisfy similar needs for different target audiences. Products in a product line may vary in size, color, quality, etc.

Differentiation is a source of competitive advantage. Although research in a niche market may result in changing a product in order to improve differentiation, the changes themselves are not differentiation. Marketing or product differentiation is the process of describing the differences between products or services, or the resulting list of differences. This is done in order to demonstrate the unique aspects of a product and to create a sense of value. To succeed, any differentiation must be valued by buyers or consumers. The term “unique selling proposition” generally refers to a desirable benefit that product or service exclusively provides or offers versus competition. For example, Zyrtec OTC Allergy Medication, manufactured by McNeil-PPC, Inc., of Ft. Washington, Pa., promotes the unique selling proposition of providing the fastest allergy relief among 24 hour OTC medications.

The differences across a product line may be minor, yet nonetheless significant to consumers. The physical product need not change, but it could. Differentiation is due to buyers perceiving a difference, hence causes of differentiation may or may not be functional aspects of the product or service, how it is distributed and marketed, or who buys it. The major sources of product differentiation are: differences in quality, functional features or design, and availability (e.g. timing and location).

The objective of product differentiation is to develop a position for a given product that potential customers see as unique. Methods of differentiation include differences in packaging, color, graphics, size, texture, orientation, or an advertising theme. There are many known examples of differentiation of products or components of product lines by color. For instance, food products are often colored differently to distinguish one flavor from another across a product line. For example, the color yellow is used to denote lemon flavor, red is cherry flavor, and purple is grape flavor. In another common example, packaging for hair dyes routinely printed with a portion of the package equivalent to the color or shade of the dye contained therein. Different color shades thus are used to denote functional differences across a line of products. In the above-described cases, either differences in colors are used to differentiate products across a product line, or shades of color are used to denote functional differences across a line of products.

Brand blocking is a term used in marketing to describe a merchandising practice in which a particular brand is differentiated or set apart from other brands. A common manner of brand blocking is to stock all of a brand's SKU's contiguously on the shelf, thereby creating a de facto billboard for the brand. Another common manner of brand blocking (which may be used separately from or in conjunction with contiguous stocking of all of the brand's SKUS) uses consistently colored packaging throughout a product line. Consistent logos, packaging, or other brand identifiers that unify the various products of a particular brand or a particular product line of a brand may also be used.

### SUMMARY OF THE INVENTION

In accordance with the principles of the present invention, a color family is used to differentiate and to set apart, or “block,” a line of products (“product line”) all having in common a primary attribute for which the product line is known and/or by which the product line is identified. The primary characteristic may be one or more functional characteristics. Variations of colors within the color family are used to differentiate the variations of the products in the product line, such variations pertaining to characteristics other than the primary attribute of the product line. For instance, differences between product variants in the product line may pertain to non-functional characteristics or the addition of other functional characteristics without affecting the common characteristics associated with the product line. Thus, uniformity is created across the product line by the use of a single color family, yet consumers may readily distinguish a specific desired variant in the product line by selecting the desired specific color in the single color family corresponding to the desired product variant. In one embodiment, the product line has in common two or more, and most preferably more than two, functional characteristics so that the color family is indicative of a product bearing such characteristics and signals to the consumer that that product has the desired characteristics. Variations of the color indicate to the consumer a variation in a non-functional characteristic, such as flavor, or scent, or texture.

The use of a color family to unify and to distinguish a product line may be applied in a variety of manners. For instance, the product may itself have the desired color. Or, the packaging for the product may have the desired color. The colors in the family may vary by hue, tint, or shade, or a combination thereof, depending on the color family. If desired, the color family may bear no relation to the functional or non-functional characteristics of the product.

These and other features and advantages of the present invention will be readily apparent from the following detailed description of the invention, the scope of the invention being set out in the appended claims.

### DETAILED DESCRIPTION OF THE INVENTION

The present invention provides a method of identifying or distinguishing a product line that also permits differentiation of the various products or product variants (hereinafter “product variants” for the sake of convenience, without intent to limit) in the product line. The product line may be known to have a primary attribute (such as disinfecting, moisturizing, pain relieving, sanitizing, cleansing, etc.) that distinguishes the product line. The primary attribute may be a single characteristic or feature, or a set of characteristics, preferably functional characteristics (such as a multipurpose cleanser, a mouth rinse having germ-fighting as well as tooth-strengthening properties, a shampoo with conditioner), that are common to all products in the product line. Despite having a common primary attribute characteristic of the product line, the various product variants in a product line typically vary according to any of a variety of attributes such as flavor, fragrance, color, size, form (gel, liquid, solid, powder), packaging (tube, bottle, stick, powder), or ingredients or additives (other than those ingredients or additives affecting the primary attribute specific to and identifying and distinguishing the product line). Although differences in size, form, or packaging are relatively evident visually, and therefore provide their own ready differentiation among such products in the product line, other differences among the products in the product line may not be as readily perceived or evident to a consumer without closer inspection of the various products.

In accordance with the principles of the present invention, a product line having a primary attribute common to the product line, and for which the product line preferably is known, is identified and grouped and unified by associating all products in the product line with a single color family. Consumers thereby can readily identify the product line by its color and can readily be directed to the appropriate area in a product display or planogram for the product segment or category in which the product line belongs. Further in accordance with the principles of the present invention, the variations of products in the product line (hereinafter “product variants” for the sake of convenience and without intent to limit) are differentiated from one another by variations in the product-line-identifying color family. Because a single color family is used to identify a product as belonging to the product line, the variations in the colors of the product variants in the product line are variations within the color family that do not cause any such color variation to fall outside of or to leave the color family, as will now be described with reference to the following definition and description of color terminology and terms relevant to features and principles of the present invention.

For the purpose of the present invention, primary colors are defined as the three colors that, when mixed together and in different combinations, create all other colors. In elementary school, the primary colors were defined as red, yellow, and blue. However, the definition of primary colors (and thus secondary colors as well), is not necessary limited to the colors red, yellow, and blue. The primary colors of light are red, green, and blue. These are the colors used, for example, for the phosphors of cathode-ray tube (CRT) screens. In contrast, the primary colors of pigment are cyan, magenta, and yellow. These three colors are used, for example, for inkjet printer ink.

Secondary colors are created when two primary colors are mixed together. Using the common primary colors of red, yellow, and blue, the secondary colors are orange (red plus yellow), violet or purple (red plus blue), and green (blue plus yellow). Using the primary colors of light (red, green, and blue), the secondary colors of light are yellow (green plus red), cyan (green plus blue), and magenta (red plus blue). Mixing the three primary colors of ink or pigment (cyan, magenta, and yellow) in different proportions onto a white sheet of paper produces various printed colors. Mixing all three of the pigment primary colors produces black. Magenta, yellow, and cyan are close enough to red, yellow, and blue that the primary colors of pigment and the primary colors taught in elementary school are often used interchangeably.

Tertiary colors are created by combining a primary color with a secondary color. Such colors generally include analogous colors, which are defined as colors that are “like” or “similar” to other colors. For example, yellow-green and blue-green are tertiary colors that are analogous colors to green. A series of analogous colors may be created by changing the ratio of the colors being blended. Brown and gray may also be considered tertiary colors.

The pure form of a primary color is the color itself without addition of another color, white, or black. The pure form of a secondary color may be described as a 50%-50% ratio of the two primary colors making up that secondary color (other ratios typically resulting in a color that may be considered a tertiary rather than secondary color). Variations to a color can be variations in tint, shade, hue, or the ratio of colors making up the secondary or tertiary color. When white is added to a color, the color is diluted and produces a “tint” of such color (also referred to as “pastels”). A “shade” of a color is created when black is mixed with the color. Brilliance and luminosity are terms used to describe the amount of black mixed with the color to create the shade. “Zero brilliance” or “zero luminosity” is black. Whenever a color is “diluted” by mixing white or black into it, the color loses saturation. For example, the color pink is created by mixing red with white. Technically, the color pink can be described as “a tint of red” or “low-saturation red.”

A “color family,” as used herein, refers to a group of colors that is associated or identified with a specific color, typically a primary or secondary color. For instance, a “red color family” could include pure red, and tints and shades of red. A “purple color family” or “violet color family” could include not only tints and shades of purple or violet, but also a range of colors that would be considered “purple” or “violet” yet which have varying ratios of combinations of red and blue. A bluish-purple/violet would contain more blue than red, whereas a reddish-purple/violet would contain more red than blue, yet both of these colors may be considered to be within the purple or violet color family. Similarly, an “orange color family” would include not only tints and shades of orange, but also a range of colors that would be considered “orange,” such as melon orange, burnt orange, yellow-orange, or red-orange.

In accordance with the principles of the present invention, a single color family is used to identify and/or to unify a set of products in a product line. The product itself, or the packaging for the product, is in a color within the selected color family. In the case of the product itself being in a color within the selected color family, the product preferably is visible. Thus, if the product is to be packaged within a container or the like, the container preferably has a window or is sufficiently transparent to permit the color of the colored product to be sufficiently viewable by a consumer to permit the consumer to identify the product by such color. If the packaging for the product is the article bearing the color identifying the product line, then the color must be used on a sufficiently large percentage of the displayed surface area of the packaging to permit a consumer to identify the product by such color. The sufficiency of visibility of the selected color is readily determinable by surveys such as those used in the marketing and sales fields to assess the amount of time a typical consumer needs to assess a planogram for a given product category or segment and to select the desired product within such planogram.

The use of a single color family to identify a product line in accordance with the principles of the present invention may serve to unify the product line, particularly in the eyes of a consumer. Preferably, the products in the product line are associated by sharing common features or characteristics or a primary attribute for which the product line may be known. As such, the selected color family serves as an indicator or identifier of a product with the common features or characteristics or attributes known to be provided by the product family. Preferably, though not necessarily, such features or characteristics are functional or provide one or more particular benefits, such as a desired therapeutic affect (e.g., pain relief, antibacterial, disinfecting, cleaning, moisturizing, oral care, etc.).

A product line to which the principles of the present invention may be applied preferably contains various different products or variants of the product. The differences between the product variants in the product line may be differences functional or non-functional characteristics, or the presence of an additional functional characteristic. Typically, the differences between variants in a product line to which the principles of the present invention are applied involve non-functional characteristics, such as flavor, fragrance, form (gel, liquid, solid, powder), ingredients, or additives, such characteristics not affecting the primary attribute or set of characteristics specific to and identifying and distinguishing the product line. As such, the use of a single color family for a given product line with a shared primary attribute or set of characteristics logically indicates a commonality among the variants in the product line. However, it will be appreciated that product variants in the product line may vary by having additional functional characteristics outside the set of characteristics common to all product variants in the product line. Thus, in accordance with the principles of the present invention, the single color family indicates that a product in the product line has the primary attribute (such as a set of characteristics) associated with the product line, and variants within the product line bear a color within the selected color family for that product line, the color of each variant differing from the color of the other variants in the product line, yet still falling within the single color family of the product line.

Differences in color are provided in accordance with one aspect of the present invention to assist consumers in selecting the desired variant or particular product in a product line containing more than one product. As such, the present invention provides a unique manner of brand blocking a product line by identifying the product line with a single color family, yet differentiating the variants in the product line by using different variants of colors in the color family for each product variant. A product line of products with a common primary attribute or set of characteristics is thus provided in accordance with the principles of the present invention in a single color family, and variations in colors within the single color family are assigned to each variant in the product line. The color variations thus serve a product differentiation function to differentiate the variants from one another on the store shelf. It will be appreciated that the principles of the present invention are particularly suited for application to a product line having variants sold individually, rather than to sets of various related products (in which case the set, as a whole and sold as a unit, contains the variants). As such, the single color family serves a consumer differentiation function (differentiating products on display for purchase at a retail store), in contrast with an end user differentiation function (differentiating related products sold together as a set from one another during use of the set).

The features or characteristics or attributes that differentiate the product variants may be ones that are not readily visually distinguishable. In other words, simple visual inspection typical of a consumer purchasing goods in the product segment or category in which the product line belongs does not reveal the differences in the time such consumer expects to make his or choice of product. For instance, the consumer would be required to inspect the packaging or labeling (in contrast with simply looking at the overall appearance of the product or the brand name of the product) in order to differentiate the various products in the product line. In contrast, variants of a product line having different shapes or sizes generally may readily be determined visually in substantially the same amount of time that a difference in color would serve to differentiate such variants. Accordingly, the principles of the present invention are particularly suited for application to a product line with variants which differ in a manner that is not solely visually detectable. Accordingly, the use of variations of colors in the single color family identifying the product line to differentiate variants in the product family imparts a visual indicator of differences that would not otherwise be readily detectable visually.

The manner in which the principles of the present invention are applied to a product line may be affected by the type of product in the product line. Certain products may themselves be formulated to be in the color family identifying the product line. Such colored products preferably are contained in clear packaging permitting the color of the product to be seen through the packaging to permit identification of the product line as a whole and differentiation of the variants in the product line. For example, a liquid product line may comprise a variety of liquid products all colored in the same color family. The container for such liquids may be clear or may have a window permitting the color of the liquid to be visible for identification of the particular product. If the product cannot be formed or formulated to be in the color family identifying the product line, or if the product is light-sensitive and cannot be packaged in a clear container or a container with a window, then the container or packaging preferably is formed in the product-line-identifying color family.

In order to achieve the above-described inventive product line in which a variety of different product in the product line are formed in one of a variety of colors all in the same color family, the present invention further includes selecting a single color family to identify or to unify a product line and formulating the product in the selected single color family. The present invention further includes a method of formulating a product line of various product variants all having a common primary attribute. Colorants are selected and added to the product to impart the product with a color within the color family for the product line to which the product belongs without altering the primary attribute of the product line. More particularly, the active ingredients of the formulation preferably are not affected and do not affect the colorants imparting the product line color to the product. Of course, if the active ingredients interact with the colorants, appropriate modifications of the colorants (proportions of different colorants to be added, the amount of colorant to be added, the type of colorant to be added, etc.) are within the scope of the present invention. In one example, if the color family for a product line is a secondary color, then the proportions of the primary colors making up the secondary color may be varied to create various color analogues for each of the various product line variants, each color analogue still close enough to the secondary color to be considered within the color family of the secondary color. Alternatively, the saturation of the color may be varied among the product variants in the product line to generate a variety of differently saturated colors in the same color family common to the product line.

An exemplary application of the principles of the present invention is to a multi-benefit product line providing more than one and preferably two or more functional benefits. Such product line may be considered to be a therapeutic line of products. In accordance with the principles of the present invention, a single color family is selected to signal a set of products containing the same set of benefits. Such set may include all the same benefits, or a selected number of common benefits (some variants having additional benefits not provided by other variants, but all variants providing a minimum number of common benefits considered characteristic of the product line). Different variations of colors all within the common color family of the product line are used to differentiate the variants in the product line. The products in the product line may vary by non-functional or non-therapeutic characteristic.

In accordance with one aspect of the present invention, the color family identifying a product line is not associated with the primary attribute of the product line. The color family may not even be associated with other characteristics of the product line. For instance, as described above, some colors are commonly associated with particular characteristics, such as the association of the color yellow with a lemon flavor. In accordance with the principles of the present invention, the color family selected for a product line may be unrelated to the primary characteristic of the product line. In the context of the present invention, “unrelated” means lacking a common relation a typical consumer would expect between the color and the primary characteristic of the product variants in the product line. Such common relation may be determined not only by opinions of average consumers, but also with reference to marketing and sales data. The various colors in the color family used for the different product variants in the product line do not have to correlate to the non-functional aspect and are not necessarily indicative of the given non-functional characteristic setting a particular variant apart from another variant. For instance, if the product line includes more than two variants which all have a common set of benefits, yet which vary by flavor, then the color family for the product line may be completely unrelated to the flavors to be used in the product line. Particular examples embodying the principles of the present invention will now be described.

One embodiment of a product line incorporating one or more of the above-described principles of the present invention is a mouthwash or mouth rinse product line. Each product in the product line may comprise the same set of active ingredients; with the difference between the different products across the product line is one or more non-active (or non-functional) ingredients, or the inclusion of an additional active ingredient. For example, flavor may be a non-functional ingredient in a mouth wash or mouth rinse. Or the addition of fluoride to one or some, but not all, of the variants would differentiate variants from one another, while all variants still share the primary attribute of the product line. A single color family may be used in accordance with the principles of the present invention to identify the mouthwash or mouth rinse product line, with different tints or shades or analogues within the color family being used to identify the variations within the product line. For instance, a purple color family may be used for a mouthwash or mouth rinse with a primary attribute or set of functional characteristics, and various purples (depending on the ratio of red and blue making up the purple) may be used for different flavors. The primary attribute may be a set of functional benefits such as one or more of the following oral care benefits: prevention of cavities; restoration of tooth enamel; strengthening of teeth; killing of bad breath germs; freshening of breath; fighting of unsightly plaque above the gum line. In such example, it is noted that the color family identifying the product line may bear no relation to the flavor. Purple is generally identified with grape flavors, whereas mouthwashes and mouth rinses typically are mint—a flavor typically associated with a green color family. The variations to the color of the selected color family may or may not be associated with the non-functional characteristic which such color variation indicates. For instance, a purple with more red than blue may be used for a cinnamon-mint flavor (cinnamon typically being associated with the color red), whereas a purple with more blue than red may be used for a berry-mint flavor (blue typically being associated with berries such as blueberry).

Another embodiment of a product line incorporating one or more principles of the present invention is an air freshener product line. Each product in the product line may comprise the same set of active ingredients for neutralizing unpleasant odors. The differences among the different products in the product line can be one or more non-active (or non-functional) ingredients. For example, fragrance may be a non-functional ingredient in an air freshening product. By packaging the products in packaging using different tints or shades or analogues of a color of a selected color family, non-functional differences in different air freshening products across a product line of air freshening products may be identified.

Yet another embodiment of a product line incorporating one or more principles of the present invention is a hand sanitizer product line. Each product in the product line may comprise the same set of active ingredients (germicides, for example); with the difference among the different products across the product line being one or more non-active (or non-functional) ingredients. For example, fragrance may be a non-functional ingredient in a hand sanitizing product. By using different tints or shades or analogues of the color selected to identify the product line, non-functional differences in different hand sanitizing products across the product line may be identified.

Various embodiments of the invention have been set forth above. Each embodiment is provided by way of explanation of the invention, not limitation of the invention. In fact, it will be apparent to those skilled in the art that various modifications and variations can be made to the above-described embodiments without departing from the scope or spirit of the invention. For instance, features illustrated or described as part of one embodiment can be used in connection with another embodiment to yield a still further embodiment, whether or not explicitly indicated. The various features described herein may be used singly or in any combination thereof. Thus, it is intended that the present invention cover such modifications and variations as come within the scope of the appended claims and their equivalents. It will be appreciated that the present invention is not limited to only the embodiments specifically described herein.

The present invention may be better understood with reference to the following examples.

### Example 1

### Mouth Rinse Formulations with Analogous Colors

Two mouth rinse formulas were prepared with the following components:

| | Formula A | Formula B |
|---|---|---|
| Ingredient | % | % |
| Alcohol | 15.00 | 15.00 |
| Menthol | 0.05 | 0.050 |
| Thymol | 0.05 | 0.050 |
| Methyl Salicylate | 0.05 | 0.050 |
| Eucalyptol | 0.050 | 0.050 |
| Mint Flavor | 0.50 | — |
| Berry Flavor | — | 0.60 |
| Sodium Lauryl Sulfate | 0.40 | 0.40 |
| Sorbitol solution | 10.00 | 10.00 |
| Benzoic Acid | 0.20 | 0.20 |
| Sodium Benzoate | 0.050 | 0.050 |
| Saccharin Sodium | 0.10 | 0.150 |
| Sodium Fluoride, | 0.020 | 0.020 |
| FD&C Red 40 | 0.00100 | 0.00150 |
| FD&C Blue 1 | 0.00020 | 0.00030 |
| Purified Water | QS to 100% | QS to 100% |

Formula A contains a mint flavor, while Formula B contains a berry flavor. The remainder of each formula contains the same ingredients in the same amount, with the exception of the total amounts of FD&C red 40 and FD&C blue 1. Formula B contains 50% more of these dyes than Formula A. This results in a visibly deeper shade of purple for Formula B when compared to Formula A.

While the foregoing description and drawings represent exemplary embodiments of the present invention, it will be understood that various additions, modifications and substitutions may be made therein without departing from the spirit and scope of the present invention. One skilled in the art will appreciate that the invention may be used with many modifications of materials and otherwise, used in the practice of the invention, which are particularly adapted to specific requirements without departing from the principles of the present invention. The presently disclosed embodiments are therefore to be considered in all respects as illustrative and not restrictive, the scope of the invention being indicated by the appended claims, and not limited to the foregoing description.

What is claimed is:

1. A method of identifying a product line having more than one variant, each product in said product line having a primary attribute characteristic of said product line, and each product variant varying from the other product variants in said product line by a feature other than said primary attribute, said method comprising:
selecting a single color family to identify all products in said product line; and
assigning a different color from within said single color family to each variant in said product family to differentiate said variants without causing the color identifying a product in said product line to fall outside said single color family.

2. A method as in claim 1, further comprising packaging each product variant in said product line in packaging colored in a color selected from said single color family.

3. A method as in claim 1, further comprising forming each product variant in said product line in a color selected from said single color family.

4. A method as in claim 1, wherein each product variant is a separate stock keeping unit sold separately from the other product variants.

5. A method as in claim 1, wherein said primary attribute of said product line is a functional characteristic, and said variants vary from one another by non-functional characteristics.

6. A method as in claim 1, wherein said single color family is unrelated to the functional characteristics of said product variants.

7. A method as in claim 1, wherein varying the color of said single color family for each variant in said product family includes varying the percentage of primary colors from which said single color is formed, varying the shade, or varying the tint.

8. A product line of products, said product line comprising a plurality of product variants sharing a primary attribute characteristic of said product line, wherein:
said product line is identified by a single color family with which each of said plurality of product variants in said product line is associated;
each product variant varies from the other product variants in said product line by a feature other than said primary attribute; and
a different color from within said single color family is associated with each product variant in said product family to differentiate said product variants without causing the color identifying a product in said product line to fall outside said single color family.

9. A product line as in claim 8, wherein each product variant in said product line is packaged in packaging colored in a color selected from said single color family.

10. A product line as in claim 8, wherein each product variant in said product line is colored in a color selected from said single color family.

11. A product line as in claim 10, wherein said product line is a product line of liquid products with variants each colored in a color unique to said variant and within said single color family.

12. A product line as in claim 11, wherein at least two variants of said product line are packaged in a clear package permitting viewing of the different colors of said at least two variants to permit differentiation of said at least two variants from each other.

13. A product line as in claim 12, wherein a first product variant is contained in a package in a color selected from said single color family and unique to said first product variant.

14. A product line as in claim 11, wherein:
said liquid products are oral care products;
said primary characteristic of said product line includes a set of functional characteristics related to oral health treatment; and
all variants in said product line have said set of functional characteristics and provide oral health treatments associated with said set of functional characteristics.

15. A product line as in claim 8, wherein each product variant is a separate stock keeping unit sold separately from the other product variants.

16. A product line as in claim 8, wherein said primary attribute of said product line is a functional characteristic, and said variants vary from one another by non-functional characteristics.

17. A product line as in claim 16, wherein said single color family is unrelated to the functional characteristics of said product variants.

18. A product line as in claim 8, wherein at least one variant has a functional characteristic not provided in other variants in said product line.

19. A product line as in claim 8, wherein said colors of said product variant in said product family vary by percentage of primary colors from which said single color is formed, shade, or tint.

20. A product line as in claim 8, wherein each variant is packaged for sale as a separate stock keeping unit.

21. A product line as in claim 8, wherein said product variants differ in characteristics that are not visually perceptible in said product variants.

22. A method of formulating a product line having more than one variant, each variant having a primary attribute characteristic of said product line, said method comprising:
formulating each product variant in said product line with at least one active ingredient imparting to each product variant said primary attribute characteristic of said product line; and
coloring each product variant in a different color, each different color being within the same color family, such that all variants in said product line are colored in a color belonging to the same color family.

23. A method as in claim 22, wherein said primary attribute is a functional characteristic permitting said product line to provide at least one functional benefit.

24. A method as in claim 22, further comprising formulating at least one product variant with an active ingredient imparting a functional characteristic different from said primary attribute functional characteristic.
